(19) United States
(12) Patent Application Publication
(10) Pub. No.: US 2026/0336108 A1
(43) Pub. Date: Oct. 29, 2026

(54) Method for Operating a Multi-Jointed Robot Arm

(71) Applicant: KUKA Deutschland GmbH, Augsburg (DE)

(72) Inventor: Andreas Sedlmayr, Fuerstenfeldbruck (DE)

(73) Assignee: KUKA Deutschland GmbH, Augsburg (DE)

(21) Appl. No.: 19/657,782

(22) Filed: Apr. 24, 2026

(30) Foreign Application Priority Data
Apr. 25, 2025 (DE) DE102025116119

(51) Int. Cl. B25J 9/16; B25J 9/06

(52) U.S. Cl. CPC B25J 9/1638; B25J 9/06; B25J 9/1633

(57) ABSTRACT

A method for operating a multi-jointed robot arm includes determining at least one selected Cartesian degree of freedom of the robot arm and a contacting operating mode including determining a target load for at least one selected Cartesian degree of freedom of the robot arm and a target pose variable for at least one other Cartesian degree of freedom based on an actuation of an input device input element; determining a position control load component based on the target pose variable and a determined actual pose variable for the at least one other Cartesian degree of freedom by position control; determining a pre-control load component to compensate for the robot arm's own weight and/or joint friction based on a determined actual pose variable of the robot arm, and a force control load component based on the determined target load and the determined pre-control load component by force control. Drives of the robot arm are operated by drive control based on the determined position control load component and the determined force control load component, without loads between links of the robot arm being detected by joint load sensors.

### CROSS-REFERENCE TO RELATED APPLICATIONS

This application claims the benefit of priority under 35 U.S.C. § 119(a) to German Patent Application No. DE 10 2025 116 119.4, filed Apr. 25, 2025, the disclosure of which is incorporated by reference herein in its entirety.

### TECHNICAL FIELD

The present invention relates to a method for operating a multi-jointed robot arm, and to a system and a computer program or computer program product for carrying out the method.

### BACKGROUND

From internal company practice, it is known to operate robot arms using position control on the basis of predetermined target pose variables and determined actual pose variables, for example, a Cartesian position of a TCP.

Such (pure) position controls can lead to undesirably high contact forces, unwanted vibrations and the like, especially when the robot arm, in particular a robot-arm-guided tool, makes contact with its surroundings, for example a workpiece to be processed, in a manually guided manner.

Therefore, it is also known from internal company practice to operate robot arms using force control. Loads are detected using load sensors, for example loads between links of the robot arm are detected using joint load sensors or contact loads at an end link are detected using a contact load sensor, and on the basis of this and desired loads, for example target contact forces, drives of the robot arm are operated by means of drive control on the basis of a corresponding load control difference.

Force control of this kind is complex and in particular expensive due to these load sensors.

### SUMMARY

The object of the present invention is to improve the operation of robot arms, preferably to make it (more) cost-effective.

This object is achieved by a method, a system, and a computer program or computer program product for carrying out a method as described herein.

According to one embodiment of the present invention, a method for operating a multi-jointed robot arm comprises the step of:
determining one or more selected Cartesian degrees of freedom of the robot arm, in a development on the basis of user input, wherein in one embodiment this user input is part or a step of an inventive method and/or is input or will be input by means of an operator interface, preferably on the input device described below.

According to one embodiment of the present invention, the method comprises a contacting operating mode comprising the following steps, which are preferably repeated multiple times, in particular cyclically:
determining a target load for the selected Cartesian degree(s) of freedom of the robot arm on the basis of an actuation, preferably adjustment, of a, preferably movable, input element of a or the input device, preferably on the basis of a predefined relation and/or such that a stronger actuation, in particular a larger adjustment, in the corresponding degree(s) of freedom corresponds to a larger target load in these degrees of freedom;
determining a target pose variable for one or more other Cartesian degrees of freedom of the robot arm, preferably for the remaining or unselected Cartesian degrees of freedom of the robot arm, on the basis of the actuation of the input element, preferably on the basis of a predefined relation and/or such that a stronger actuation, in particular a larger adjustment, in the corresponding degree(s) of freedom corresponds to a larger target pose change in these degrees of freedom; and
determining a position control load component on the basis of the determined target pose variable and a determined actual pose variable, determined in a development using one or more pose sensors, for the other Cartesian degree(s) of freedom by means of position control.

Determining, in particular selecting, the (selected) Cartesian degree(s) of freedom can be carried out in particular before or in the contacting operating mode or when switching into the contacting operating mode; in particular, switching into the contacting operating mode can be performed by the selection.

In one embodiment, a Cartesian degree of freedom of the robot arm is a position of a robot-arm-fixed reference, for example a TCP, in a Cartesian direction or a rotational position or orientation of the robot-arm-fixed reference about a Cartesian axis in the workspace of the robot arm.

In one embodiment, a load within the meaning of the present invention comprises a one-or multi-dimensional force and/or a one-or multi-dimensional torque, and may in particular be one or more such force or torque. Accordingly, in one embodiment a joint load sensor is a single-or multi-axis torque sensor for detecting a one-or multi-dimensional torque between two robot links attached to each other in a joint, preferably at least one torque about a rotation axis of the joint, and/or a single-or multi-axis force sensor for detecting a one-or multi-dimensional force between two robot links attached to each other in a joint, preferably at least one force along a thrust axis of the joint, in one embodiment a force-torque sensor. A target load can also be, in particular, zero and/or a so-called power winder.

A pose within the meaning of the present invention comprises, in one embodiment, a one-or multi-dimensional position and/or a one-or multi-dimensional orientation, preferably of a or the robot arm-fixed reference, in particular of a TCP, a pose variable in one embodiment, such a one-or multi-dimensional position and/or one-or multi-dimensional orientation and/or a first and/or higher temporal derivative of such a position and/or orientation, in particular a translational and/or rotational velocity and/or acceleration.

Control on the basis of a (control difference between a) target pose variable and an actual pose variable is referred to in the present case as position control, so that position control within the meaning of the present invention may in particular also comprise velocity control (pose variable comprises a time derivative of a position and/or orientation), a differential and/or integral component and/or control of orientations or rotations.

According to one embodiment of the present invention, the contacting operating mode or the method in its contacting operating mode comprises the following steps, which may also be repeated multiple times or cyclically:
determining a pre-control load component to compensate for the robot arm's own weight and/or joint friction on the basis of an actual pose variable of the robot arm determined in a development using one or more pose sensors;
determining a force control load component on the basis of the determined target load and the determined pre-control load component by means of force control; and
operating drives of the robot arm by means of drive control, in a development of a current controller, on the basis of the determined position control load component and the determined force control load component, without loads between links of the robot arm being detected by means of joint load sensors, preferably also without contact loads on or at an end link of the robot arm being detected by means of a (contact) load sensor.

In contrast to force or hybrid force-position control of all degrees of freedom of a robot arm, or impedance control or force control with impedance behavior or a compliant degree of freedom for a position, the novel idea behind this is to select one or more Cartesian degrees of freedom in a contacting operating mode and to operate the robot arm in a flexible or compliant manner within these degrees of freedom, wherein in (the) other Cartesian degrees of freedom, the robot arm is (operated so as to be) position-controlled, in a development (maximally) rigidly and/or via cascade control in the joint space, and thus advantageously following the inputs via the input element (more) rigidly, wherein in the selected degree(s) of freedom, the compliant behavior of the robot arm is not achieved by comparing actual loads, detected by means of load sensors, with a target load for this (these) degrees of freedom, but rather by load control that comprises a pre-control load component to compensate for the robot arm's own weight and/or joint friction, and a control load component determined on the basis of the target load.

This advantageously eliminates the need for joint load sensors and/or contact load sensors required for force control, thereby improving the operation of the robot arm, and in particular making the robot arm more (cost-)effective to operate. Accordingly, in one embodiment, the robot arm does not comprise joint load sensors for detecting loads between links of the robot arm and/or does not comprise contact load sensors for detecting contact loads on or at an end link of the robot arm.

The idea can be qualitatively illustrated in an embodiment in the following way: if, for example, the selected degree of freedom is the gravitational axis perpendicular to the robot arm base, then a pre-control load component is imposed in this axis by the drives of the robot to compensate for the robot arm's own weight. If the user actuates the input element counter to the direction of gravity in order to guide the robot arm in that direction, joint friction of the robot arm is additionally compensated by the pre-control load component, and a force counter to the direction of gravity is additionally imposed according to the actuation of the input element, so that the robot arm accelerates counter to the direction of gravity.

By using only (pre-)control to compensate for the robot arm's own weight and joint friction, according to the actuation of the input element or the resulting target load or target force, instead of detecting loads using load sensors, comparing them with desired loads and operating the drives on the basis of this control difference, the operation of the robot arm can be improved, and in particular, the robot arm can be operated more cost-effectively. At the same time, in contrast to pure position control of all Cartesian degrees of freedom, contact between the robot and its surroundings can be improved: while in pure position control the increasing position controller differential (due to very short operator inputs at the contact) leads to ever higher (integral) drive loads (and these high drive loads persist when the operator input is immediately terminated), force control with the pre-control load component to compensate for the robot arm's own weight and/or joint friction and the additional component of the force control load, determined on the basis of the target load, advantageously (further) limits the drive loads.

In one embodiment, the input device is arranged on the robot arm; in a development, it is arranged on a distal or end link of the robot arm. Additionally or alternatively, the input element has at least three degrees of freedom in one embodiment, in a development four, five or, particularly preferably, six; the element can be, for example, a so-called space mouse or the like.

For corresponding multi-dimensional hand guidance directly on the robot arm, the present invention is particularly advantageous, in particular due to the operating conditions, in particular with regard to processing feedback, caused by shrinkage of the arm and the stiffness of a spring-loaded space mouse or the like, using signal-processing technology.

In one embodiment, the method additionally comprises a transfer operating mode, in which:
the target pose variable is determined on the basis of an actuation, preferably adjustment, of the, preferably movable, input element also for the Cartesian degrees of freedom of the robot arm selected in the contacting operating mode, preferably for all Cartesian degrees of freedom of the robot arm;
a position control load is determined on the basis of the determined target pose variable (which is determined on the basis of an actuation of the input element for the selected Cartesian degree(s) of freedom and for the other Cartesian degree(s) of freedom of the robot arm) and a determined actual pose variable, determined in a development using the pose sensor(s), for (these) Cartesian degrees of freedom by means of position control; and
the drives of the robot arm (in the transfer operating mode) are operated by means of the drive control on the basis of this determined position control load.

Since, in addition to the contacting operating mode, in which the robot arm is flexibly or compliantly (pre-)controlled in one or more selected Cartesian degrees of freedom without loads being detected by load sensors, and a pre-control load component is instead used to compensate for the robot arm's own weight and/or joint friction, a transfer operating mode is provided, in which the Cartesian degrees of freedom selected in the contacting operating mode are also position-controlled by means of position control, the robot arm can be moved advantageously, in particular (more) quickly, precisely and/or robustly, toward or away (again) from a contact region by behaving flexibly or compliantly in the selected Cartesian degree(s) of freedom. This can (further) improve the operation of the robot arm.

In one embodiment, the method comprises, in addition to the contacting operating mode and, if applicable, the transfer operating mode, a processing operating mode in which the force control load component is determined not on the basis of the target load determined on the basis of an actuation of the input element, but on the basis of a working load specified via an operator interface, which in a development may be arranged on the input device and thereby improve its operation.

This can be qualitatively illustrated again using the example already explained above: if the operator has guided a robot-arm-guided tool or workpiece (by hand) along the axis of gravity, with respect to which the robot arm behaves flexibly or compliantly, in contact with an environmentally rigid workpiece or tool, he can switch to the processing operating mode in which, instead of a target load dependent on an actuation of the input element, a target load specified via an operator interface is used, so that in the processing operating mode the operator does not have to adjust the input element and instead a target load can be specified or achieved (more) precisely, or in a development, constantly, for example in order to achieve a corresponding contact force during a processing process, which can serve in particular to maintain contact (automatically) and thus easily detect an uneven surface contour, a curved edge profile or the like using the position sensors of the robot arm.

In one embodiment, preferably on the basis of a selection command input via an operator interface, which in a development can be arranged on the input device and thereby improve its operation, switching is carried out from the contacting operating mode to the transfer operating mode and/or from the contacting operating mode to the processing operating mode and/or from the transfer operating mode to the contacting operating mode and/or from the processing operating mode to the contacting operating mode.

In one embodiment, in a development, the determination of the pre-control load component for compensating joint friction of the robot arm is machine-learned by means of training by at least one operator; in particular, the corresponding training or machine learning can be part or a step of an inventive method.

The underlying assumption is that compensating for the robot arm's own weight can be achieved simply, precisely and reliably using kinematic and mass data of the robot arm or in a model-based manner. Accordingly, in one implementation, the determination of the pre-control load component(s) to compensate for the robot arm's own weight is based on kinematic and mass data and/or a numerical model of the robot arm. Compensation for joint friction of the robot arm can in particular comprise compensation for coulombic and/or viscous friction, in particular a breakaway load and/or a change in frictional load between sticking and sliding. A corresponding friction behavior or compensation thereof can be implemented particularly advantageously, in particular (more) easily, precisely and/or reliably, by means of (training in) machine learning.

This training can, in particular, comprise determining and, in particular, adapting the pre-control load component in such a way that, without actuation of the input element or in its zero position in the selected degree(s) of freedom, no movement of the robot arm occurs in these degrees of freedom, or the drives are operated accordingly; and/or that a direction of actuation of the input element in the selected degree(s) of freedom and a resulting movement of the robot arm in these degrees of freedom are the same, or the drives are operated accordingly; and/or that a stronger actuation of the input element in the selected degree(s) of freedom causes a larger and/or faster movement of the robot arm in these degrees of freedom, or the drives are operated accordingly.

Additionally or alternatively, this training can comprise, in particular, storing training data for later control operations on this robot arm, and/or keeping this data personal or person-specific, or carrying out this training in a personal or person-specific manner, so that different operating behaviors when handling devices can be differentiated. Accordingly, the determination of the pre-control load component to compensate for joint friction of the robot arm, by means of training by at least one operator, can be machine-learned in a person-related or person-specific manner or take place in a personal or person-specific manner.

Training by the (relevant) operator can take place in particular (so to speak indirectly) during a planned (work) operation of the robot arm or, preferably, directly before a (work) operation in a (preliminary) learning procedure; in particular, training data can be acquired indirectly or during a planned (work) operation of the robot arm or with the help of custom teach exercises.

By means of the inventive load (pre-)control in the selected degree(s) of freedom instead of force control in these degree(s) of freedom (by means of (detection of loads on or between links of the robot arm by means of) load sensors), a robot arm that is already moving as a result of the target load can continue to move after the actuation of the input element is discontinued due to the compensation of the robot arm's own weight and/or joint friction. This can be counteracted by an operator, in particular by actuating the input element in the opposite direction or by releasing the input element, for example an operating button, which preferably returns to the zero position automatically.

In one embodiment, the pre-control load component comprises a damping component, preferably a damping term, which counteracts a movement of the robot arm in the selected Cartesian degree(s) of freedom and, in a development, depends on a velocity and/or pose of the robot arm in these degrees of freedom. Thus, in particular, a Cartesian virtual constraint to a desired pose can be achieved by a corresponding damping component, which can therefore, in general terms, not only have (velocity-dependent and/or virtual) damping loads, but also or alternatively (pose-dependent and/or virtual) spring loads and, in particular, at least one virtual wall, or can simulate them. This allows, in particular, the aforementioned movement of the robot arm to be slowed down, so that the operator does not have to adjust the input element, and the stability of the operation can be improved.

In one embodiment, at least one (first) of the drives of the robot arm is operated on the basis of the determined force control load component, and one or more other (second) of the drives of the robot arm, preferably the remaining drives of the robot arm, are operated on the basis of the determined position control load component and a determined actual drive variable of the at least one (first) drive; in particular, this at least one (first) of the drives can serve as a flexibly or compliantly switched guide axis, which the other axes follow in a position-controlled manner, as is explained in particular in DE 10 2009 018 403 A1, to which reference is made for further information and the content of which is incorporated into the present disclosure, wherein the force control load component is used inventively for the compliant control of at least one guide axis mentioned therein.

According to one embodiment of the present invention, a system for operating a multi-jointed robot arm, in particular in terms of hardware and/or software, in particular in terms of programming, is configured to carry out a method described herein and/or comprises:
means for determining at least one selected Cartesian degree of freedom of the robot arm;
means for determining
a target load for the at least one selected Cartesian degree of freedom of the robot arm and
a target pose variable for at least one other Cartesian degree of freedom of the robot arm
on the basis of the actuation of an input element of an input device in a contacting operating mode;
means for determining a position control load component
on the basis of the determined target pose variable and a determined actual pose variable for the at least one other Cartesian degree of freedom
by means of position control in the contacting operating mode;
means for determining
a pre-control load component to compensate for the robot arm's own weight and/or joint friction
on the basis of a determined actual pose variable of the robot arm; and
a force control load component
on the basis of the determined target load and the determined pre-control load component
by means of force control in the contacting operating mode; and
means for operating drives of the robot arm in the contacting operating mode by means of drive control on the basis of the determined position control load component and the determined force control load component, without loads between links of the robot arm being detected by means of joint load sensors, preferably also without contact loads on or at an end link of the robot arm being detected by means of a (contact) load sensor.

In one embodiment, the system additionally comprises a transfer operating mode, in which
the target pose variable is also determined for the at least one selected Cartesian degree of freedom of the robot arm, on the basis of an actuation of the movable input element;
a position control load is determined on the basis of the determined target pose variable and a determined actual pose variable for Cartesian degrees of freedom by means of position control; and
the drives of the robot arm are operated by means of the drive control on the basis of the determined position control load.

In one embodiment, the system also comprises a processing operating mode in which the force control load component is determined not on the basis of the target load determined on the basis of actuation of the movable input element, but on the basis of a working load specified via an operator interface.

In one embodiment, the system comprises data processing, at least partially based on machine learning, for determining the pre-control load component to compensate for joint friction of the robot arm, which is trained by at least one operator or has learned the determination by machine learning or performs the machine-learned determination.

In one embodiment, the system comprises means for operating at least one (first) of the drives of the robot arm on the basis of the determined force control load component and at least one other of the drives of the robot arm on the basis of the determined position control load component and a determined actual drive variable of the at least one (first) drive.

A system and/or means within the meaning of the present invention may be designed as hardware and/or software, in particular may comprise at least one, in particular digital, processing unit, in particular microprocessor unit (CPU), graphics card (GPU), or the like, which is preferably data-connected or signal-connected to a memory system and/or bus system, and/or one or more programs or program modules, in particular one or more, preferably correspondingly programmed, computers. The processing unit may be designed to process commands that are implemented as a program stored in a memory system, to acquire input signals from a data bus and/or to deliver output signals to a data bus. A memory system may comprise one or more, in particular different, memory media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate the robot arm. In one embodiment, a computer program product may comprise, in particular be, an, in particular computer-readable and/or non-volatile, memory medium for storing a program or instructions or with a program stored thereon or with instructions stored thereon. In one embodiment, execution of a said program or its instructions by a system or a control unit, in particular a computer or an arrangement of multiple computers, causes the system or the controller, in particular the computer(s), to execute a method described herein or one or more steps thereof, or the program or the instructions are configured to do so.

In one embodiment, one or more, in particular all, steps of the method are fully or partially computer-implemented or one or more, in particular all, steps of the method are fully or partially automated, in particular by the system or its means.

In one embodiment, the system comprises the robot arm and/or the input device and/or operator interface and/or the drive control one or more drive controllers, in a development current controllers, for operating the drives.

Further advantages, features and advantageous developments of the present invention will become apparent from the description of the exemplary embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts an exemplary system for operating a multi-jointed robot arm according to one embodiment of the present invention;

FIG. 2 schematically depicts an exemplary data processing system for operating the robot arm; and

FIG. 3 illustrates a method for operating the robot arm according to one embodiment of the present invention.

### DETAILED DESCRIPTION

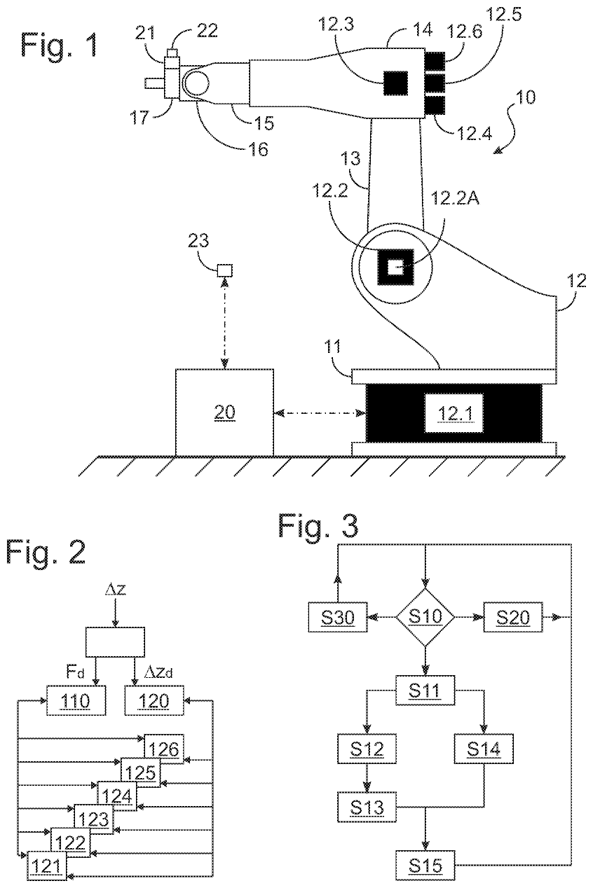

FIG. 1 depicts an exemplary system for operating a multi-jointed robot arm 10 by means of a controller 20 which can communicate with an operator interface 23.

An input device 21 with a movable input element 22, for example a space mouse or the like, is arranged on an end flange 17 of the robot arm 10.

Using the operator interface 23, which can also be arranged on the input device 21, a switch is carried out to a contacting operating mode (FIG. 3: step S10→step S11) and before, during or after this step, at least one Cartesian degree of freedom is selected in which the robot arm is to behave flexibly or compliantly.

In the contacting operating mode, on the basis of an actuation Δz of the movable input element 22, a target load F_{d} is determined for the at least one selected Cartesian degree of freedom of the robot arm, and a target pose variable Δz_{d} is determined for the other Cartesian degrees of freedom of the robot arm (FIG. 3: step S11), for a simpler and clearer explanation, for example a target load or target pose change proportional to the actuation, wherein other relationships may also be provided.

By means of force control 110 (see FIG. 2), in step S12 a pre-control load component is determined on the basis of an actual pose variable of the robot arm 10, which is determined by means of pose sensors, to compensate for the robot arm's 10 own weight and/or joint friction, and in a step S13 a force control load component is determined on the basis of the determined target load F_{d} and this determined pre-control load component. For illustrative purposes, (only) one pose sensor 12.2A is shown.

By means of position control 120 (see FIG. 2), a position control load component is determined in a step S14 on the basis of the determined target pose variable Δz_{d} and the determined actual pose variable for the other Cartesian degrees of freedom.

In a step S15, drives 12.1, . . . , 12.6 of the robot arm are operated by means of drive controllers 121, . . . , 126 on the basis of the determined position control load component and the determined force control load component.

According to the invention, no loads between links 11-17 of the robot arm 10 are detected by means of (non-existent) joint load sensors and no contact loads on the end link 17 of the robot arm are detected by means of (non-existent) (contact) load sensors.

Instead of the contacting operating mode described above, by input via the operator interface 23, a transfer operating mode (FIG. 3: S20) can be selected, in which position control is used for all Cartesian degrees of freedom, including those selected in the contacting operating mode, or a processing operating mode (FIG. 3: S30) can be selected, in which the target load F_{d}, instead of being determined on the basis of the actuation of the movable input element 22, can be determined on the basis of a work load specified via the operator interface 23.

In the present disclosure, “comprises an X” generally does not imply an exhaustive list; rather, it is a short form of “comprises at least one X” and also covers “comprises two or more Xs” and “also comprises Y in addition to X.” Although exemplary embodiments have been described in the preceding description, it should be noted that a variety of modifications are possible. It should also be noted that the exemplary embodiments are merely examples and are not intended to restrict the scope of protection, the applications, or the structure in any way. Rather, the preceding description provides a person skilled in the art with guidelines for implementing at least one exemplary embodiment, with various changes, in particular with regard to the function and arrangement of the described components, being able to be made without departing from the scope of protection as defined by the claims and these equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 robot arm
11, . . . , 17 robot arm link
12.1, . . . , 12.6 drive
12.2A pose sensor
20 controller
21 input device
22 input element
23 operator interface
110 force control
120 position control
121, . . . , 126 drive controller
F_{d} target load
Δz_{d} target pose variable
Δz actuation

What is claimed is:

1. Method for operating a multi-jointed robot arm (10), wherein the method comprises the step of:
determining (S10) at least one selected Cartesian degree of freedom of the robot arm; and
comprises a contacting operating mode with the following steps:
determining (S11)
a target load (F_{d}) for the at least one selected Cartesian degree of freedom of the robot arm and
a target pose variable (Δz_{d}) for at least one other Cartesian degree of freedom of the robot arm
on the basis of an actuation (Δz) of an input element (22) of an input device (21);
determining (S14) a position control load component
on the basis of the determined target pose variable and a
determined actual pose variable for the at least one other Cartesian degree of freedom
by means of position control (120);
determining
a pre-control load component to compensate for the robot arm's own weight and/or joint friction, on the basis of a determined actual pose variable of the robot arm (S12); and
a force control load component
on the basis of the determined target load and the determined pre-control load component (S13)
by means of force control (110); and
operating (S15) drives (12.1-12.6) of the robot arm by means of drive control

(121-126) on the basis of the determined position control load component and the determined force control load component, without loads between links of the robot arm being detected by means of joint load sensors.

2. Method according to claim 1, characterized in that the input device is arranged on the robot arm and/or the input element has at least three degrees of freedom.

3. Method according to either of the preceding claims, characterized in that a transfer operating mode (S20) is additionally provided, in which
the target pose variable is also determined for the at least one selected Cartesian degree of freedom of the robot arm on the basis of an actuation of the input element;
a position control load is determined on the basis of the determined target pose variable and a determined actual pose variable for Cartesian degrees of freedom by means of position control; and
the drives of the robot arm are operated by means of the drive control on the basis of the determined position control load.

4. Method according to any of the preceding claims, characterized in that a processing operating mode (S30) is additionally provided, in which the force control load component is determined not on the basis of the target load determined on the basis of an actuation of the input element, but on the basis of a working load specified via an operator interface.

5. Method according to any of the preceding claims, characterized in that the determination of the pre-control load component for compensating for joint friction of the robot arm is machine-learned by means of training by at least one operator.

6. Method according to any of the preceding claims, characterized in that the pre-control load component comprises a damping component which counteracts a movement of the robot arm in the at least one selected Cartesian degree of freedom.

7. Method according to any of the preceding claims, characterized in that at least one of the drives of the robot arm is operated on the basis of the determined force control load component, and at least one other of the drives of the robot arm is operated on the basis of the determined position control load component and a determined actual drive variable of the at least one drive.

8. System for operating a multi-jointed robot arm (10), which is designed to carry out a method according to any of the preceding claims, and/or which comprises:
means for determining at least one selected Cartesian degree of freedom of the robot arm;
means for determining
a target load (F_{d}) for the at least one selected Cartesian degree of freedom of the robot arm and
a target pose variable (Δz_{d}) for at least one other Cartesian degree of freedom of the robot arm
on the basis of an actuation (Δz) of an input element (22) of an input device (21) in a contacting operating mode;
means for determining a position control load component on the basis of the determined target pose variable and a determined actual pose variable for the at least one other Cartesian degree of freedom
by means of position control (120) in the contacting operating mode;
means for determining
a pre-control load component to compensate for the robot arm's own weight and/or joint friction on the basis of a determined actual pose variable of the robot arm; and
a force control load component on the basis of the determined target load and the determined pre-control load component,
by means of force control (110) in the contact operating mode; and
means for operating drives (12.1-12.6) of the robot arm in the contacting operating mode by means of drive control (121-126) on the basis of the determined position control load component and the determined force control load component, without loads between links of the robot arm being detected by means of joint load sensors.

9. Computer program or computer program product, wherein the computer program or computer program product contains instructions, in particular stored on a computer-readable and/or non-volatile memory medium, which, when executed by one or more computers or a system according to claim 8, cause the computer(s) or the system to carry out a method according to any of claims 1 to 7.
